(19) United States
(12) Patent Application Publication
(10) Pub. No.: US 2026/0179862 A1
(43) Pub. Date: Jun. 25, 2026

(54) SINGLE-HAND OPERATED TRIGGER DEVICE

(71) Applicant: SPEED TECH CORPORATION, TAOYUAN CITY (TW)

(72) Inventors: Ying Yen HUANG, TAOYUAN CITY (TW); Chien Lin CHENG, TAOYUAN CITY (TW); Hsuan Ju LIU, TAOYUAN CITY (TW)

(21) Appl. No.: 19/225,102

(22) Filed: Jun. 2, 2025

(30) Foreign Application Priority Data
Dec. 23, 2024 (CN) 2024119067793

(51) Int. Cl. H01H 13/14; H01H 13/04; H01H 13/10

(52) U.S. Cl. CPC H01H 13/14; H01H 13/04; H01H 13/10

(57) ABSTRACT

The application provides a single-hand operated trigger device, which includes a switch assembly, a base assembly, a pressing assembly, and a control mechanism. The switch assembly comprises a first contact element and a second contact element. The base assembly includes multiple first extension members, which are disposed on opposite sides of the support structure in the second direction and extend toward the second contact element along the first direction. The abutment element of the pressing assembly abuts against the first contact element, and multiple second extension members are disposed on opposite sides of the pressing body in the second direction and extend toward the first contact element along the first direction. The control mechanism includes multiple abutment protrusions and multiple abutment slots, which are respectively arranged on the multiple first extension members and the multiple second extension members.

### CROSS-REFERENCE TO RELATED APPLICATIONS

This application claims the benefit of priority to the China patent application No. 2024119067793, filed on Dec. 23, 2024; the entirety of which is incorporated herein by reference for all purposes.

### BACKGROUND

### Technical Field

The present application relates to the technical field of trigger devices for wearable and portable equipment, and more particularly, to a single-hand operated trigger device.

### Related Art

In certain industries that require inventory management, such as the retail or logistics industry, operators need to scan the barcodes of goods using a scanning device to perform sorting, picking, or inventory checks. Some manufacturers have developed wearable accessories that allow portable scanners to be worn on the palm to facilitate inventory management operations, such as the ZEBRA RS2100 Bluetooth wearable scanner. The wearable accessory includes a housing and a trigger switch, wherein the operator wears the fabric-based wearable accessory on the palm, places the scanner inside the housing, and presses the trigger switch to activate the scanner for scanning.

### SUMMARY

In view of the shortcomings of the prior art described above, the present application aims to provide a single-hand operated trigger device.

To achieve the aforementioned objectives and other related purposes, the present application provides a single-hand operated trigger device, which includes a switch assembly, a base assembly, a pressing assembly, and a control mechanism. The switch assembly comprises a first contact element, a second contact element, a first lead wire electrically connected to the first contact element, and a second lead wire electrically connected to the second contact element. The first contact element moves along a first direction to contact the second contact element to form a conduction state, or separates to form an open circuit state. The base assembly includes a support structure and multiple first extension members, wherein the support structure supports the second contact element, and the multiple first extension members are disposed on opposite sides of the support structure in a second direction and extend toward the second contact element along the first direction, wherein the second direction is orthogonal to the first direction. The pressing assembly includes a pressing body, an abutment element, and multiple second extension members, wherein the abutment element extends from the pressing body toward the first contact element along the first direction, and the abutment element abuts against the first contact element. The multiple second extension members are disposed on opposite sides of the pressing body in the second direction and extend toward the first contact element along the first direction. The control mechanism is disposed on the multiple first extension members and the multiple second extension members, wherein the control mechanism includes multiple abutment protrusions and multiple abutment slots, and the multiple abutment protrusions are respectively abutted against the inner walls of the multiple abutment slots in the first direction. A force application side is defined as the side of the pressing body where force is applied, and an abutment side is defined as the side of the pressing body opposite to the force application side. At least one abutment protrusion on the abutment side remains abutted against the inner wall of the abutment slot, thereby causing the abutment element to push the first contact element to move along the first direction and contact the second contact element. The abutment element abuts against a single contact position of the first contact element.

Optionally, the multiple first extension members are further disposed on opposite sides of the support structure in a third direction, and the multiple second extension members are further disposed on opposite sides of the pressing body in the third direction, wherein the third direction is perpendicular to both the first direction and the second direction.

Optionally, the multiple abutment protrusions are respectively disposed on the multiple first extension members, and the multiple abutment slots are respectively disposed on the multiple second extension members.

Optionally, the multiple second extension members are interconnected to form an extended peripheral wall.

Optionally, the multiple abutment protrusions abut against the inner walls of the abutment slots adjacent to the switch assembly.

Optionally, each abutment protrusion is disposed at the end of a first extension member, and a relief gap is provided between the end of the first extension member and the pressing body.

Optionally, the multiple abutment protrusions are respectively disposed on the multiple second extension members, and the multiple abutment slots are respectively disposed on the multiple first extension members.

Optionally, the multiple first extension members are interconnected to form an extended peripheral wall.

Optionally, the multiple abutment protrusions abut against the inner walls of the abutment slots away from the switch assembly.

Optionally, each abutment protrusion is disposed at the end of a second extension member, and a relief gap is provided between the end of the second extension member and the support structure.

Optionally, the first contact element is an arcuate spring plate that protrudes away from the second contact element along the first direction, and the abutment element abuts against the apex of the first contact element.

Optionally, the support structure includes multiple support ribs, wherein the multiple support ribs extend in the second direction and/or the third direction and support the second contact element.

Optionally, the support structure further includes multiple positioning posts extending in the first direction away from the support ribs, wherein the switch assembly includes multiple positioning holes. The multiple positioning posts pass through the multiple positioning holes, thereby constraining the switch assembly on the support structure in the second direction and the third direction.

Optionally, the support structure further includes multiple snap-latch elements, wherein the multiple snap-latch elements are disposed on opposite sides of the multiple support ribs and abut against the switch assembly, thereby constraining the switch assembly on the support structure in the first direction.

Optionally, the support structure further includes two wire channels formed between the multiple support ribs and the multiple snap-latch elements, wherein a through hole is formed between two adjacent first extension members. The first lead wire and the second lead wire respectively enter the two wire channels of the support structure via the through hole.

Optionally, the device enclosure assembly is further included, wherein the device enclosure assembly comprises a housing, an electrical connector, and a locking and positioning member. The housing includes a bottom wall and an outer peripheral wall, wherein the bottom wall is connected to the outer peripheral wall to form a housing slot. A locking slot is formed in the outer peripheral wall and communicates with the housing slot. The electrical connector is connected to the first lead wire and the second lead wire and is coupled to the locking and positioning member. The locking and positioning member is engaged with the locking slot and positioned within the housing, wherein at least a portion of the electrical connector is exposed within the housing slot.

Optionally, the housing slot and the locking slot are open on opposite sides of the housing. The locking slot includes two first locking ends disposed on opposite sides thereof. The locking and positioning member includes two second locking ends disposed on opposite sides thereof and a stress relief notch positioned between the two second locking ends. The distance between the two first locking ends is smaller than the distance between the two second locking ends. The locking and positioning member undergoes stress deformation at the elastic deformation notch, thereby engaging with the locking slot. The two first locking ends and the two second locking ends form a stepped mating structure, and the second locking ends adjacent to the stress relief notch include a guiding slope.

Optionally, the locking and positioning member further includes a mating groove, wherein the mating groove is formed on the surface of the locking and positioning member adjacent to the housing slot of the housing, and the electrical connector is positioned within the mating groove.

Optionally, the electrical connector includes an electrical connector body and two electrical connection structures disposed on the surface of the electrical connector body, wherein the electrical connector body is positioned within the mating groove, and the two electrical connection structures extend into the housing slot.

Optionally, the device enclosure assembly includes a wire positioning member, wherein the housing further includes a wire positioning groove formed on the bottom wall of the housing. The first lead wire and the second lead wire are secured to the wire positioning member, and the portion of the electrical connector that connects to the first lead wire and the second lead wire abuts against the wire positioning member. The wire positioning member is coupled to the wire positioning groove through a configured fitting structure.

The single-hand operated trigger device is achieved by disposing multiple first extension members on opposite sides of the support structure of the base assembly and multiple second extension members on opposite sides of the pressing body of the pressing assembly, with these first extension members corresponding to the second extension members. The control mechanism is disposed on the multiple first extension members and the multiple second extension members, wherein the multiple abutment protrusions of the control mechanism respectively abut against the inner walls of the abutment slots. When the user applies force on the force application side of the pressing body, at least one abutment protrusion on the abutment side opposite to the force application side remains abutted against the inner wall of the abutment slot. Even if the force is applied near the edge of the pressing body, the force application side of the pressing body will not move directly until being stopped by the support structure.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of a housing and a trigger switch of a portable scanner in the prior art.

FIG. 2 is an exploded perspective view of the housing and the trigger switch shown in FIG. 1.

FIG. 3 is a perspective view of a single-hand operated trigger device according to the first embodiment of the present application.

FIG. 4 is an exploded perspective view of the single-hand operated trigger device shown in FIG. 3.

FIG. 5 is a perspective view of the single-hand operated trigger device shown in FIG. 3 from another viewing angle.

FIG. 6 is a sectional view of the single-hand operated trigger device shown in FIG. 3 taken along line A-A.

FIG. 7 is a sectional view of the single-hand operated trigger device shown in FIG. 3 taken along line B-B.

FIG. 8 is a schematic view showing the pressing body of the pressing assembly being pressed on one side in FIG. 7.

FIG. 9 is a sectional view of the single-hand operated trigger device shown in FIG. 3 taken along line C-C.

FIG. 10 is a perspective view of a single-hand operated trigger device according to the second embodiment of the present application.

FIG. 11 is an exploded perspective view of the single-hand operated trigger device shown in FIG. 10.

FIG. 12 is a perspective view of the single-hand operated trigger device shown in FIG. 10 from another viewing angle.

FIG. 13 is a sectional view of the single-hand operated trigger device shown in FIG. 10 taken along line D-D.

FIG. 14 is a sectional view of the single-hand operated trigger device shown in FIG. 10 taken along line E-E.

FIG. 15 is a schematic view showing the pressing body of the pressing assembly being pressed on one side in FIG. 14.

FIG. 16 is a sectional view of the single-hand operated trigger device shown in FIG. 10 taken along line F-F.

### DETAILED DESCRIPTION OF THE EMBODIMENTS

The embodiments of the present application are described below through specific examples. Those skilled in the art can readily understand other advantages and effects of the present application based on the disclosure of this specification. The present application may also be implemented or applied in various other embodiments. The details provided in this specification may be modified or altered in different aspects and applications without departing from the spirit of the present application.

For the convenience of description, spatial relationship terms such as "below," "under," "lower than," "beneath," "above," and "upper" may be used herein to describe the relationship between one component or feature and another component or feature as shown in the drawings. It should be understood that these spatial relationship terms are intended to include orientations other than those depicted in the drawings, as applicable to the usage or operation of the device.

In the present application, unless otherwise explicitly specified and defined, the terms "mount," "attach," "connect," and "fix" should be interpreted broadly. For example, they may refer to a fixed connection or a detachable connection, or an integral formation. They may refer to mechanical connections or electrical connections. They may indicate a direct connection or an indirect connection through an intermediate medium. Additionally, they may refer to internal communication within two components or an interaction relationship between two components, unless explicitly limited otherwise. Those skilled in the art can understand the specific meanings of the above terms in the present application based on specific circumstances.

In certain industries that require inventory management, such as the retail or logistics industry, operators need to scan the barcodes of goods using a scanning device to perform sorting, picking, or inventory checks. The wearable accessory includes a housing and a trigger switch, wherein the operator wears the fabric-based wearable accessory on the palm, places the scanner inside the housing, and presses the trigger switch to activate the scanner for scanning.

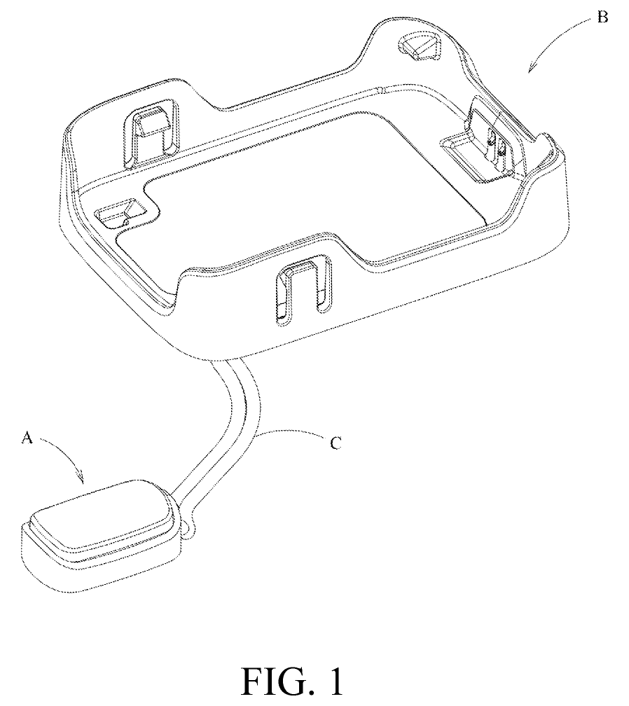

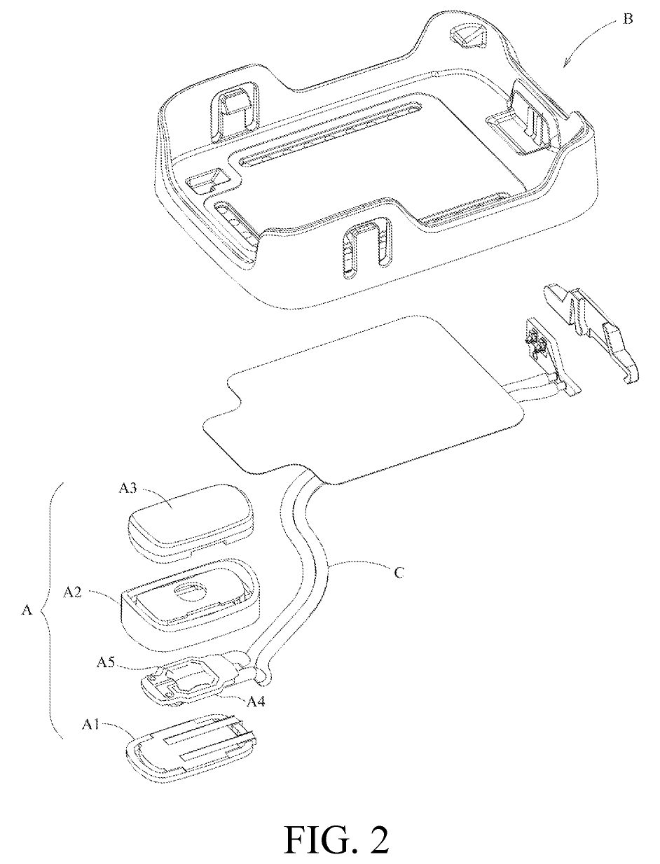

The housing and trigger switch of existing wearable accessories are shown in FIG. 1 and FIG. 2. The trigger switch A is connected to the housing B via a lead wire C, and the portable scanner is installed within the housing B. When the operator activates the trigger switch A, the portable scanner is powered on to perform scanning. When the operator releases the trigger switch A, the portable scanner ceases scanning.

The existing trigger switch A includes a base A1, a limiting support A2, and a pressing body A3. A circuit board A4 and a switch spring plate A5 are disposed on the base A1. The limiting support A2 is arranged on the base A1 and surrounds the circuit board A4 and the switch spring plate A5. The top surface of the limiting support A2 is provided with an annular groove A21 for accommodating the pressing body A3, and a protruding pin of the pressing body A3 passes through a through hole A22 on the top surface of the limiting support A2 and abuts against the switch spring plate A5.

The trigger switch A of this structure has a relatively large number of components. Additionally, if the pressing position is too close to the edge, even a slight application of force will cause the edge of the pressing body A3 to move downward until it is stopped by the wall of the annular groove A21. Consequently, no additional force can be applied, and the insufficient force fails to overcome the pressure required to move the switch spring plate A5. As a result, the edge of the trigger switch A often forms a dead zone for pressing, which is unfavorable for operating the scanner.

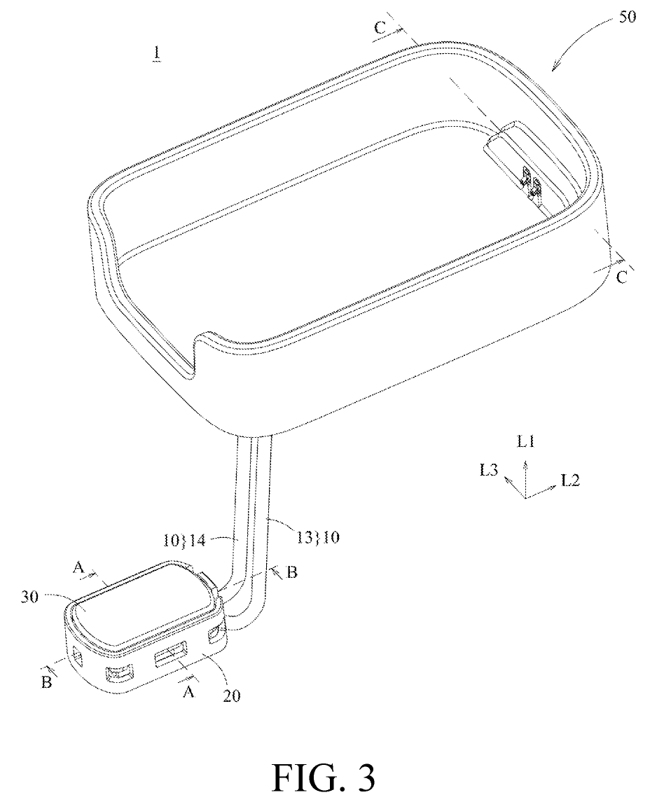

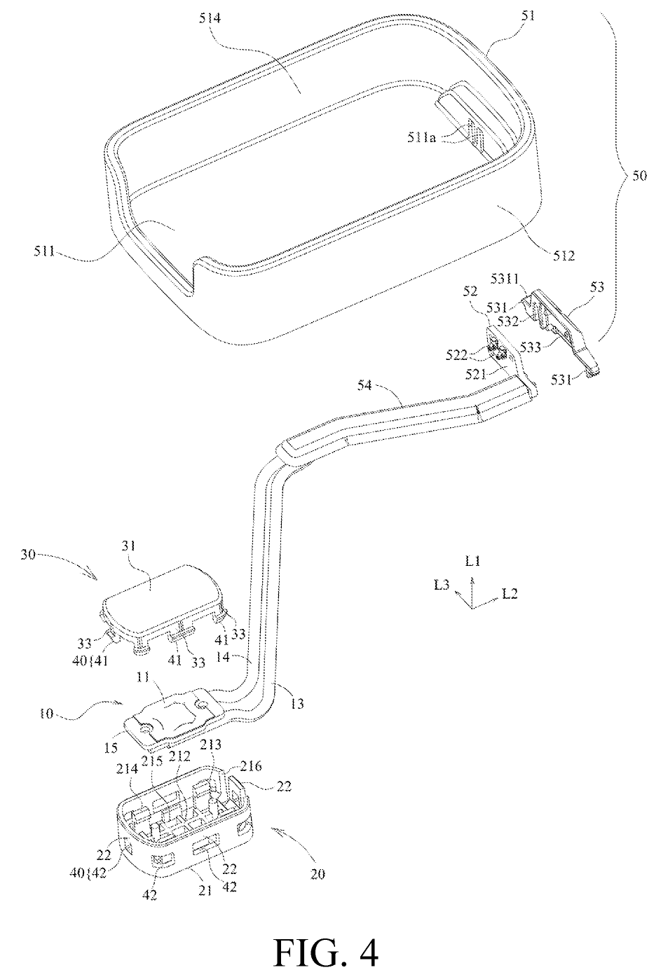

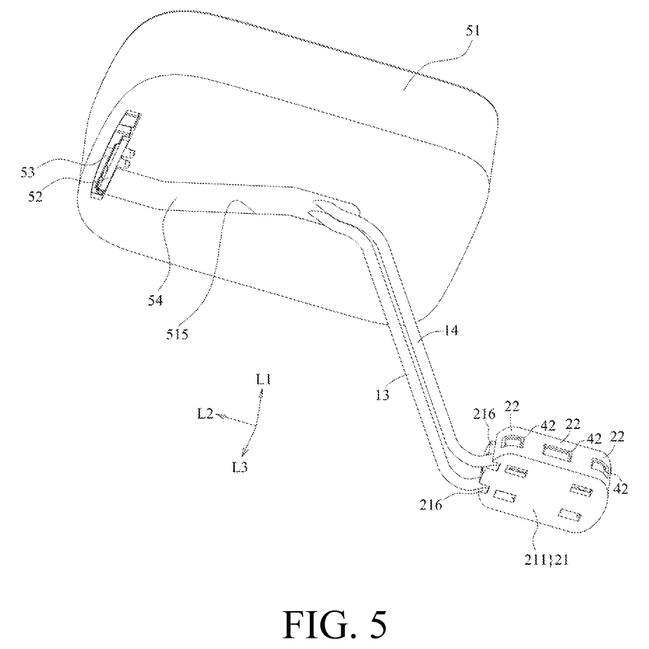

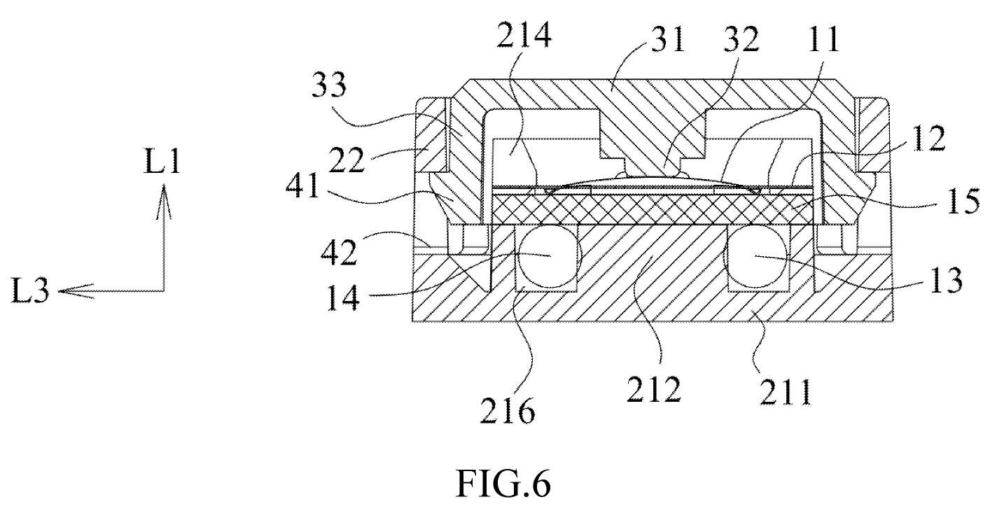

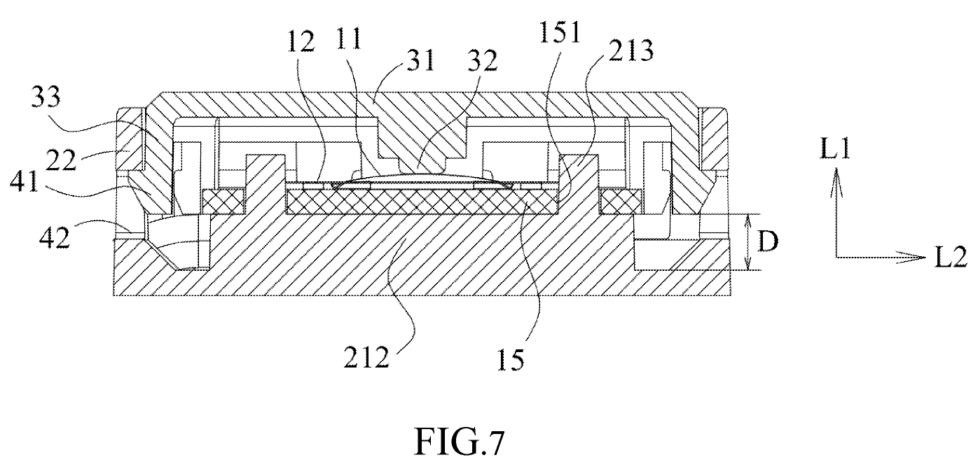

Please refer to FIGS. 3, 4, 5, 6, and 7. FIG. 3 illustrates a perspective view of the single-hand operated trigger device according to the first embodiment of the present application. FIG. 4 presents an exploded perspective view of the single-hand operated trigger device shown in FIG. 3. FIG. 5 provides a perspective view of the single-hand operated trigger device shown in FIG. 3 from another viewing angle. FIG. 6 displays a sectional view of the single-hand operated trigger device shown in FIG. 3 taken along line A-A. FIG. 7 presents a sectional view of the single-hand operated trigger device shown in FIG. 3 taken along line B-B. As shown in the figures, the single-hand operated trigger device 1 of the present embodiment includes a switch assembly 10, a base assembly 20, a pressing assembly 30, and a control mechanism 40. The single-hand operated trigger device 1 further includes a device enclosure assembly 50. The device enclosure assembly 50 accommodates an electronic device, such as a portable scanner. In the embodiment, the first direction L1 is defined as the vertical direction. The second direction L2 and the third direction L3 are two mutually perpendicular directions in the horizontal plane. The first direction L1 is perpendicular to both the second direction L2 and the third direction L3. In the embodiment, the second direction L2 corresponds to the longitudinal direction of the base assembly 20 and the pressing assembly 30. The third direction L3 corresponds to the short side direction of the base assembly 20 and the pressing assembly 30.

The switch assembly 10 includes a first contact element 11, a second contact element 12, a first lead wire 13 electrically connected to the first contact element 11, and a second lead wire 14 electrically connected to the second contact element 12. The first contact element 11 and the second contact element 12 are disposed on the circuit board 15. In the present embodiment, the first contact element 11 is an arcuate spring plate that protrudes away from the second contact element 12 along the first direction L1. The second contact element 12 is a contact structure arranged on the circuit board 15. The first contact element 11 is positioned above the second contact element 12 along the first direction L1, and its edge is disposed on the circuit board 15. The arcuate spring plate maintains a predetermined distance from the second contact element 12. The first lead wire 13 and the second lead wire 14 are electrically connected to the circuit board 15, forming electrical connections with the first contact element 11 and the second contact element 12 via the circuitry of the circuit board 15. When the first contact element 11 moves downward along the first direction L1 to contact the second contact element 12, the first lead wire 13 and the second lead wire 14 form a conduction state. Conversely, when the first contact element 11 moves upward along the first direction L1, separating from the second contact element 12, the first lead wire 13 and the second lead wire 14 form an open circuit state.

The base assembly 20 includes a support structure 21 and multiple first extension members 22. The support structure 21 supports the circuit board 15, thereby supporting the first contact element 11 and the second contact element 12. The multiple first extension members 22 extend from the edge of the support structure 21 toward the switch assembly 10 along the first direction L1. The multiple first extension members 22 are arranged in pairs on opposite sides of the support structure 21 in at least the second direction L2 and the third direction L3. In the present embodiment, the multiple first extension members 22 are interconnected to form an extended peripheral wall.

The support structure 21 includes a support structure body 211, multiple support ribs 212, multiple positioning posts 213, and multiple snap-latch elements 214. The support structure body 211 is configured as a base plate structure. The multiple support ribs 212 are arranged on the support structure body 211 and extend in the second direction L2 and/or the third direction L3 to support the circuit board 15, thereby supporting the first contact element 11 and the second contact element 12. The multiple positioning posts 213 extend away from the support structure body 211 and the support ribs 212 along the first direction L1. The circuit board 15 includes multiple positioning holes 151, and the multiple positioning posts 213 pass through the positioning holes 151, thereby constraining the circuit board 15, the first contact element 11, and the second contact element 12 in the second direction L2 and the third direction L3 relative to the support structure 21. The multiple snap-latch elements 214 are disposed on opposite sides of the support ribs 212 and extend away from the support structure body 211 along the first direction L1. The snap-latch elements 214 have barbed end structures that abut against the circuit board 15, thereby constraining the circuit board 15, the first contact element 11, and the second contact element 12 in the first direction L1 relative to the support structure 21. Accordingly, the support structure 21 also provides wire routing and strain relief functions for the first lead wire 13 and the second lead wire 14.

The support structure 21 further includes two wire channels 215, which are formed between the multiple support ribs 212 and the multiple snap-latch elements 214. A through hole 216 is formed between two adjacent first extension members 22. In the present embodiment, the through hole 216 is positioned on one side in the second direction L2. The first lead wire 13 and the second lead wire 14 respectively enter the two wire channels 215 of the support structure 21 via the through hole 216. With the circuit board 15 mounted on the support ribs 212, the circuit board 15 covers and abuts against both the first lead wire 13 and the second lead wire 14. The combination of the support ribs 212, the positioning posts 213, and the snap-latch elements 214 provides constraint for the circuit board 15 in the first direction L1, the second direction L2, and the third direction L3, while also constraining the first lead wire 13 and the second lead wire 14 in the first direction L1. Accordingly, the support structure 21 also serves as a wire management component for the first lead wire 13 and the second lead wire 14.

The pressing assembly 30 includes a pressing body 31, an abutment element 32, and multiple second extension members 33. The pressing body 31 is configured as a plate-like structure. The abutment element 32 extends from the surface of the pressing body 31 toward the switch assembly 10 along the first direction L1 and abuts against the first contact element 11. The abutment element 32 of the embodiment is cylindrical and is positioned at the center of the pressing body 31. The abutment element 32 abuts against a single contact position of the first contact element 11. The multiple second extension members 33 are disposed on opposite sides of the pressing body 31 in both the second direction L2 and the third direction L3, and extend toward the base assembly 20 along the first direction L1.

The pressing body 31 of the embodiment has a smaller dimension than the support structure 21. As a result, when the pressing assembly 30 is assembled with the base assembly 20, the second extension members 33 are positioned closer to the switch assembly 10 than the first extension members 22. That is, the second extension members 33 are positioned on the inner side of the first extension members 22.

The control mechanism 40 is disposed on the multiple first extension members 22 and the multiple second extension members 33. The control mechanism 40 includes multiple abutment protrusions 41 and multiple abutment slots 42, wherein the multiple abutment protrusions 41 are respectively abutted against the inner walls of the abutment slots 42 in the first direction L1. The abutment protrusions 41 of the embodiment are respectively disposed on the multiple second extension members 33, and the abutment slots 42 are respectively disposed on the multiple first extension members 22. The abutment protrusions 41 have a hook-like structure. Since the second extension members 33 are positioned closer to the switch assembly 10 than the first extension members 22, meaning the second extension members 33 are on the inner side of the first extension members 22, the abutment protrusions 41 extend from the side of the abutment slots 42 closer to the switch assembly 10 toward the side farther from the switch assembly 10. The abutment protrusions 41 of the embodiment abut against the inner wall of the abutment slots 42 on the side opposite to the support structure body 211. Additionally, a relief gap D is provided between the end of the second extension member 33 and the support structure body 211.

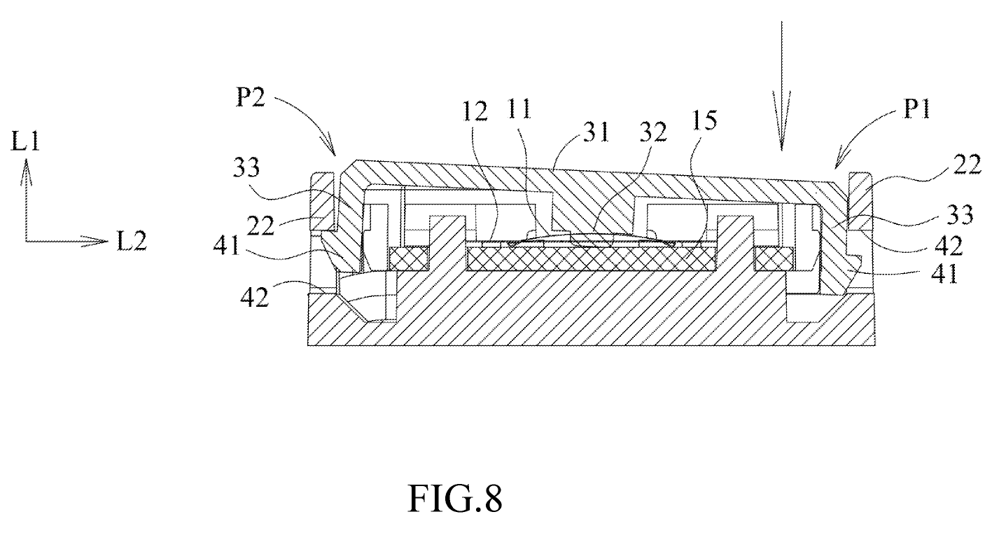

Please also refer to FIG. 8, which is a schematic view showing the pressing body of the pressing assembly being pressed on one side in FIG. 7. When the user applies force to one side of the pressing body 31, the side is defined as the force application side P1, and the opposite side of the pressing body 31 is defined as the abutment side P2. At least one abutment protrusion 41 on the abutment side P2 remains abutted against the inner wall of the abutment slot 42, allowing the user to continuously increase the applied force until the abutment element 32 pushes the first contact element 11 to move along the first direction L1 and contact the second contact element 12.

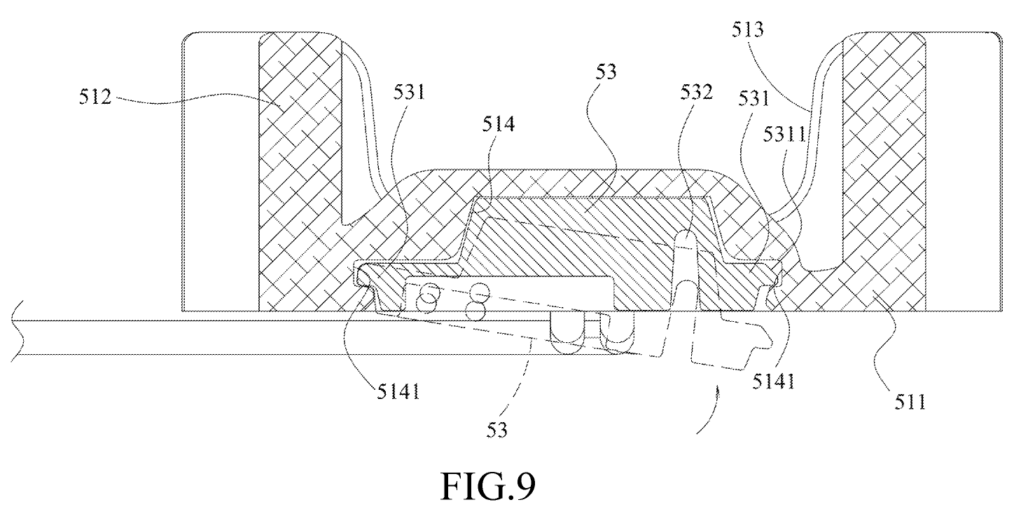

Please also refer to FIG. 9, which is a sectional view of the single-hand operated trigger device shown in FIG. 3 taken along line C-C. The device enclosure assembly 50 includes a housing 51, an electrical connector 52, and a locking and positioning member 53. The housing 51 includes a bottom wall 511 and an outer peripheral wall 512, wherein the bottom wall 511 is connected to the outer peripheral wall 512 to form a housing slot 513. A locking slot 514 is formed in the outer peripheral wall 512. The housing slot 513 and the locking slot 514 are open on opposite sides of the housing 51. The inner surface of the outer peripheral wall 512 of the housing 51 is provided with two slots 511a, allowing the locking slot 514 to communicate with the housing slot 513.

The electrical connector 52 is connected to the first lead wire 13 and the second lead wire 14 and is coupled to the locking and positioning member 53. The electrical connector 52 includes an electrical connector body 521 and two electrical connection structures 522, which are disposed on the surface of the electrical connector body 521. The locking and positioning member 53 includes a mating groove 533, which is formed on the surface of the locking and positioning member 53 adjacent to the housing slot 513 of the housing 51. The electrical connector 52 is positioned within the mating groove 533, and the two electrical connection structures 522 extend into the housing slot 513.

The locking and positioning member 53 is engaged with the locking slot 514 and positioned within the housing 51. The locking slot 514 includes two first locking ends 5141, which are disposed on opposite sides of the locking slot 514. The locking and positioning member 53 includes two second locking ends 531, which are disposed on opposite sides of the locking and positioning member 53, and a stress relief notch 532 located between the two second locking ends 531. The two first locking ends 5141 and the two second locking ends 531 form a stepped mating structure, wherein the distance between the two first locking ends 5141 is smaller than the distance between the two second locking ends 531. When the locking and positioning member 53 engages with the locking slot 514, the second locking end 531, which is farther from the stress relief notch 532, first engages with one of the first locking ends 5141 of the locking slot 514. Subsequently, the locking and positioning member 53 rotates, causing the second locking end 531 near the stress relief notch 532 to engage with the corresponding first locking end 5141. The locking and positioning member 53 undergoes stress deformation at the stress relief notch 532, thereby securing the locking and positioning member 53 within the locking slot 514. The second locking end 531, which is closer to the stress relief notch 532, includes a guiding slope 5311. When the second locking end 531 is pushed into the locking slot 514, the guiding slope 5311 abuts against the edge of the first locking end 5141, allowing smooth insertion while inducing stress deformation at the stress relief notch 532. Eventually, the second locking end 531 is fully engaged with the corresponding first locking end 5141.

As shown in FIGS. 4 and 5, the device enclosure assembly 50 further includes a wire positioning member 54. The housing 51 also includes a wire positioning groove 515, which is formed on the bottom wall 511 of the housing 51. The first lead wire 13 and the second lead wire 14 are secured to the wire positioning member 54, for example, by forming an integrated structure using an injection molding process. The portion of the electrical connector 52 that connects to the first lead wire 13 and the second lead wire 14 abuts against the wire positioning member 54. The wire positioning member 54 is coupled to the wire positioning groove 515 through a configured fitting structure.

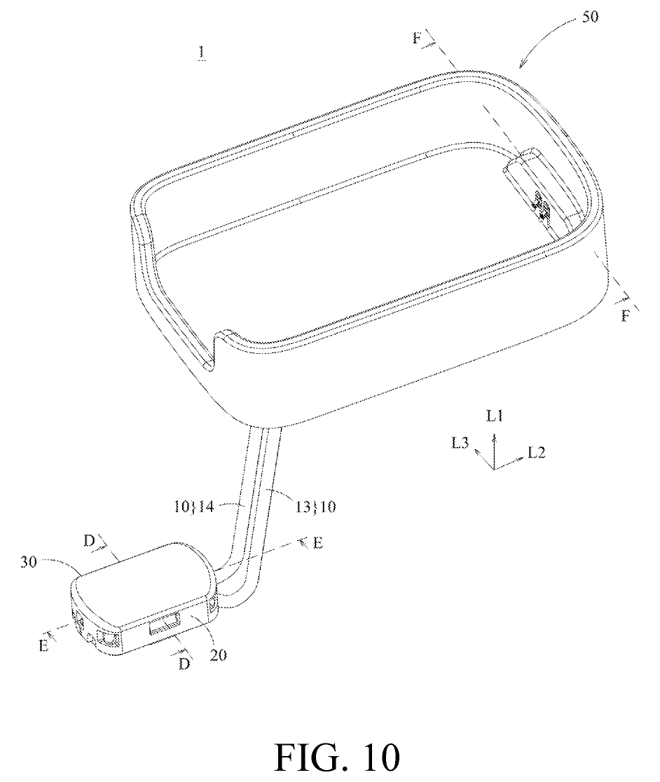

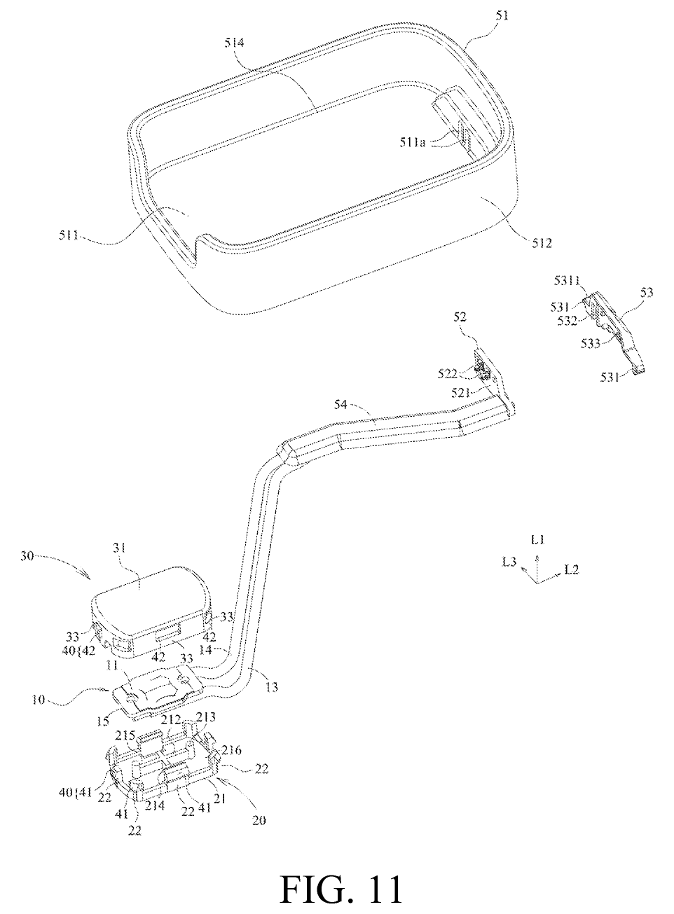

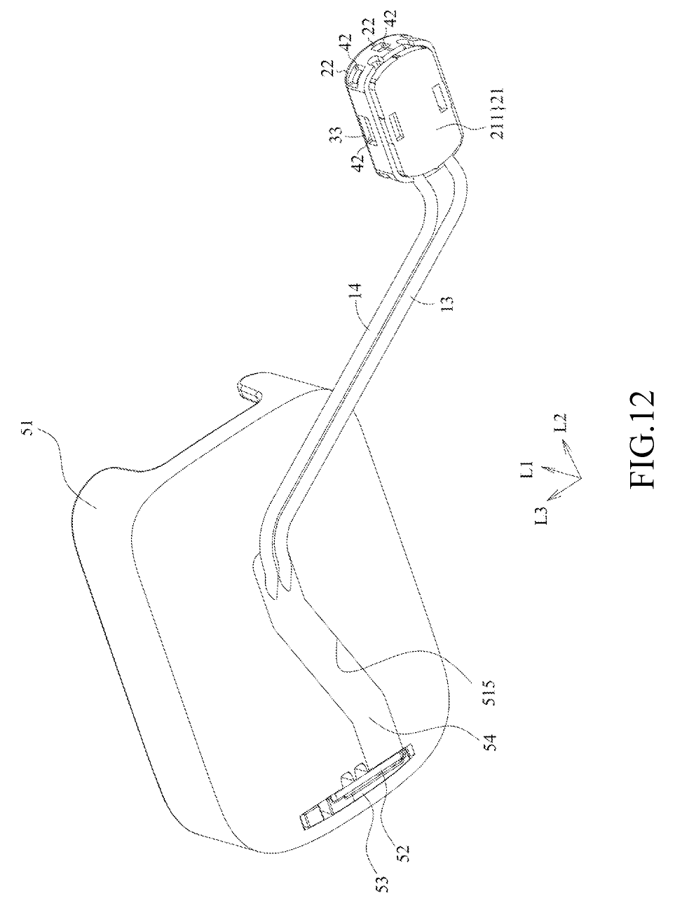

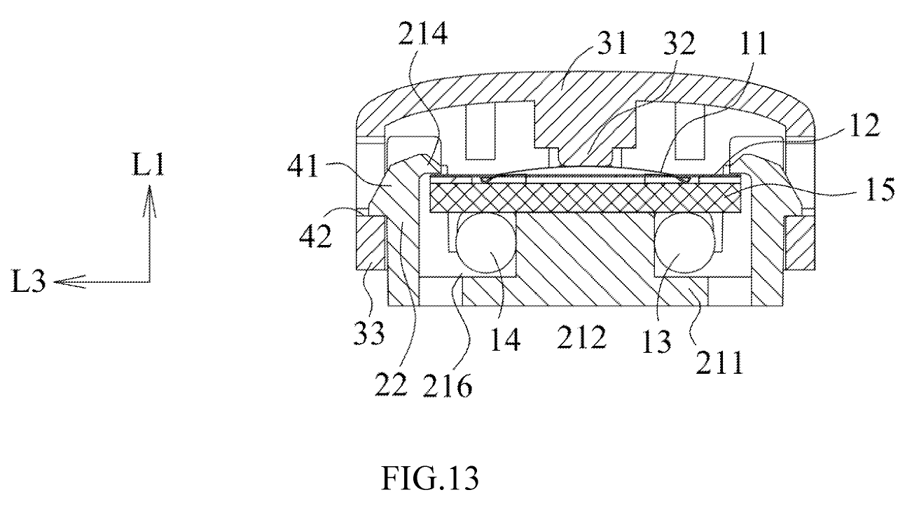

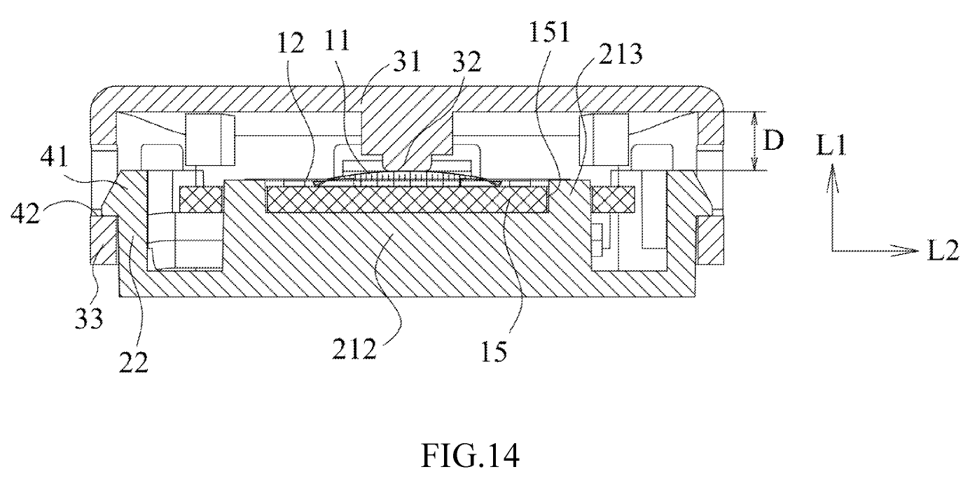

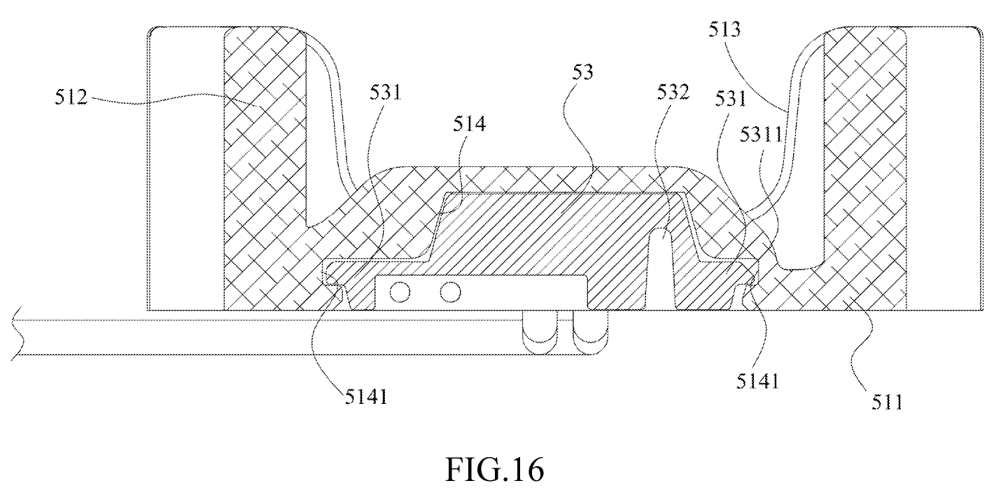

Please refer to FIGS. 10 to 16, which illustrate the single-hand operated trigger device of the second embodiment of the present application. The second embodiment shares some of the same structures as the first embodiment. Therefore, the same reference numerals are assigned to the same components, and their descriptions are omitted. The difference between the second embodiment and the first embodiment lies in the size of the pressing body 31. In the second embodiment, the pressing body 31 has a larger dimension than the support structure 21. As a result, when the pressing assembly 30 is assembled with the base assembly 20, the second extension members 33 are positioned farther from the switch assembly 10 than the first extension members 22. That is, the first extension members 22 are located on the inner side of the second extension members 33. Additionally, the abutment protrusions 41 are respectively disposed on the first extension members 22, while the abutment slots 42 are respectively disposed on the second extension members 33. Since the first extension members 22 are located on the inner side of the second extension members 33, the abutment protrusions 41 extend from the side of the abutment slots 42 closer to the switch assembly 10 toward the side farther from the switch assembly 10. The abutment protrusions 41 are abutted against the inner wall of the abutment slots 42 in the first direction L1. In the second embodiment, the abutment protrusions 41 are abutted against the inner wall of the abutment slots 42 on the side closer to the support structure 21. Additionally, a relief gap is provided between the end of the first extension member 22 and the pressing body 31.

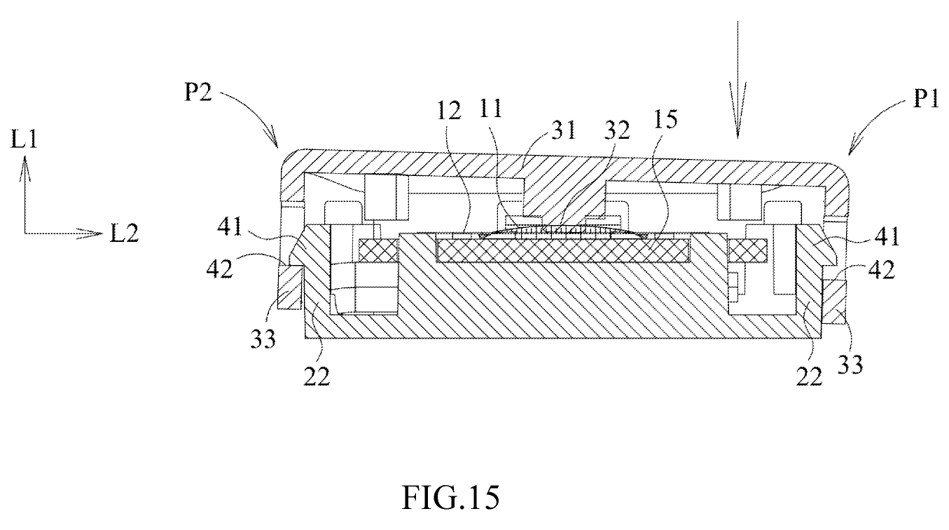

As shown in FIG. 15, when the user applies force to one side of the pressing body 31, the side is defined as the force application side P1, and the opposite side of the pressing body 31 is defined as the abutment side P2. At least one abutment protrusion 41 on the abutment side P2 remains abutted against the inner wall of the abutment slot 42, allowing the user to continuously increase the applied force until the abutment element 32 pushes the first contact element 11 to move along the first direction L1 and contact the second contact element 12.

The single-hand operated trigger device of the present application achieves an improved triggering mechanism by disposing multiple first extension members on opposite sides of the support structure of the base assembly and multiple second extension members on opposite sides of the pressing body of the pressing assembly. The multiple first extension members correspond to the multiple second extension members, and the control mechanism is disposed on the first extension members and the second extension members. The abutment protrusions of the control mechanism are respectively abutted against the inner walls of the abutment slots. When the user applies force on the force application side of the pressing body, at least one abutment protrusion on the abutment side opposite to the force application side remains abutted against the inner wall of the abutment slot. Even if force is applied near the edge of the pressing body, the force application side of the pressing body will not move directly until being stopped by the support structure. The user can continuously increase the applied force until overcoming the required force of the first contact element, thereby enabling the abutment element to push the first contact element to move and contact the second contact element. Accordingly, the single-hand operated trigger device avoids dead zones in all orientations, achieving omnidirectional triggering.

The above-described embodiments are provided solely for illustrative purposes to explain the principles and effects of the present application, and should not be construed as limiting the present application. Any person skilled in the art may modify or alter the above embodiments without departing from the spirit and scope of the present application. Therefore, all equivalent modifications or alterations made by those ordinarily skilled in the art, without departing from the spirit and technical concepts disclosed in the present application, shall still be encompassed within the scope of the claims of the present application.

What is claimed is:

1. A single-hand operated trigger device, characterized in that the single-hand operated trigger device comprises:
a switch assembly, including a first contact element, a second contact element, a first lead wire electrically connected to the first contact element, and a second lead wire electrically connected to the second contact element, wherein the first contact element moves along a first direction to contact the second contact element to form a conduction state or separates to form an open circuit state;
a base assembly, including a support structure and multiple first extension members, wherein the support structure supports the second contact element, and the multiple first extension members are disposed on opposite sides of the support structure in a second direction and extend toward the second contact element along the first direction, wherein the second direction is orthogonal to the first direction;
a pressing assembly, including a pressing body, an abutment element, and multiple second extension members, wherein the abutment element extends from the pressing body toward the first contact element along the first direction, and the abutment element abuts against the first contact element; the multiple second extension members are disposed on opposite sides of the pressing body in the second direction and extend toward the first contact element along the first direction;
a control mechanism, disposed on the multiple first extension members and multiple second extension members, wherein the control mechanism includes multiple abutment protrusions and multiple abutment slots, and the multiple abutment protrusions are respectively abutted against the inner walls of the multiple abutment slots in the first direction.

2. The single-hand operated trigger device according to claim 1, characterized in that, one side of the pressing body subjected to force is defined as a force application side, and the side of the pressing body opposite to the force application side is defined as an abutment side; at least one of the abutment protrusions on the abutment side remains abutted against the inner wall of the abutment slot, such that the abutment element pushes the first contact element to move along the first direction and contact the second contact element; and the abutment element abuts at one contact position of the first contact element.

3. The single-hand operated trigger device according to claim 2, characterized in that, the multiple first extension members are further disposed on opposite sides of the support structure in a third direction, the multiple second extension members are further disposed on opposite sides of the pressing body in the third direction, and the third direction is perpendicular to both the first direction and the second direction.

4. The single-hand operated trigger device according to claim 2, characterized in that, the multiple abutment protrusions are respectively disposed on the multiple first extension members, and the multiple abutment slots are respectively disposed on the multiple second extension members.

5. The single-hand operated trigger device according to claim 4, characterized in that, the multiple second extension members are connected to each other to form an extended peripheral wall.

6. The single-hand operated trigger device according to claim 4, characterized in that, the multiple abutment protrusions abut against the inner walls of the abutment slots adjacent to the switch assembly.

7. The single-hand operated trigger device according to claim 4, characterized in that, each abutment protrusion is disposed at an end of a first extension member, and there is a relief gap between the end of the first extension member and the pressing body.

8. The single-hand operated trigger device according to claim 2, characterized in that, the multiple abutment protrusions are respectively disposed on the multiple second extension members, and the multiple abutment slots are respectively disposed on the multiple first extension members.

9. The single-hand operated trigger device according to claim 8, characterized in that, the multiple first extension members are connected to each other to form an extended peripheral wall.

10. The single-hand operated trigger device according to claim 9, characterized in that, the multiple abutment protrusions abut against the inner walls of the abutment slots away from the switch assembly.

11. The single-hand operated trigger device according to claim 2, characterized in that, each abutment protrusion is disposed at an end of a second extension member, and there is a relief gap between the end of the second extension member and the support structure.

12. The single-hand operated trigger device according to claim 2, characterized in that, the first contact element is an arcuate spring plate protruding away from the second contact element along the first direction, and the abutment element abuts against the apex of the first contact element.

13. The single-hand operated trigger device according to claim 3, characterized in that, the support structure includes multiple support ribs extending in the second direction and/or the third direction and supporting the second contact element.

14. The single-hand operated trigger device according to claim 13, characterized in that, the support structure further includes multiple positioning posts extending in the first direction away from the support ribs, and the switch assembly includes multiple positioning holes, wherein the multiple positioning posts pass through the multiple positioning holes such that the switch assembly is constrained in the second direction and the third direction relative to the support structure.

15. The single-hand operated trigger device according to claim 13, characterized in that, the support structure further includes multiple snap-latch elements disposed on opposite sides of the multiple support ribs and abutting against the switch assembly such that the switch assembly is constrained in the first direction relative to the support structure.

16. The single-hand operated trigger device according to claim 15, characterized in that, the support structure further includes two wire channels formed between the multiple support ribs and the multiple snap-latch elements, and a through hole is formed between two adjacent first extension members, wherein the first lead wire and the second lead wire pass through the through hole and enter the two wire channels of the support structure.

17. The single-hand operated trigger device according to claim 1, characterized in that the single-hand operated trigger device further comprises a device enclosure assembly, wherein:
the device enclosure assembly includes a housing, an electrical connector, and a locking and positioning member;
the housing includes a bottom wall and an outer peripheral wall;
the bottom wall is connected to the outer peripheral wall to form a housing slot;
a locking slot is formed in the outer peripheral wall and communicates with the housing slot;
the electrical connector is connected to the first lead wire and the second lead wire, and is coupled to the locking and positioning member,
the locking and positioning member is engaged with the locking slot and positioned within the housing, and
at least a portion of the electrical connector is exposed within the housing slot.

18. The single-hand operated trigger device according to claim 17, characterized in that:
the housing slot and the locking slot are open on opposite sides of the housing;
the locking slot includes two first locking ends disposed on opposite sides of the locking slot;
the locking and positioning member includes two second locking ends disposed on opposite sides thereof and a stress relief notch positioned between the two second locking ends;
the distance between the two first locking ends is smaller than the distance between the two second locking ends;
the locking and positioning member undergoes stress deformation at the stress relief notch, allowing it to engage with the locking slot;
the two first locking ends and the two second locking ends form a stepped structure that mates with each other, and
the second locking ends, which are adjacent to the stress relief notch, include a guiding slope.

19. The single-hand operated trigger device according to claim 17, characterized in that, the locking and positioning member further includes a mating groove, and the mating groove is formed on the surface of the locking and positioning member adjacent to the housing slot of the housing, wherein the electrical connector is positioned within the mating groove.

20. The single-hand operated trigger device according to claim 19, characterized in that, the electrical connector includes an electrical connector body and two electrical connection structures disposed on the surface of the electrical connector body, wherein the electrical connector body is positioned within the mating groove, and the two electrical connection structures extend into the housing slot.

21. The single-hand operated trigger device according to claim 17, characterized in that, the device enclosure assembly includes a wire positioning member, and the housing further includes a wire positioning groove formed on the bottom wall of the housing; wherein:
the first lead wire and the second lead wire are secured to the wire positioning member;
the portions of the electrical connector that connect to the first lead wire and the second lead wire abut against the wire positioning member; and
the wire positioning member is coupled to the wire positioning groove through a configured fitting structure.
